(19) United States
(12) Patent Application Publication
(10) Pub. No.: US 2012/0030622 A1
(43) Pub. Date: Feb. 2, 2012

(54) Display apparatus

(75) Inventor: Tsuyoshi Hasegawa, Daito (JP)

(73) Assignee: Sanyo Electric Co., Ltd., Moriguchi (JP)

(21) Appl. No.: 12/804,887

(22) Filed: Jul. 30, 2010

(51) Int. Cl. G06F 3/048

(52) U.S. Cl. 715/811

(57) ABSTRACT

A display apparatus includes a display and a controller. The controller displays a plurality of menus in a hierarchy order on the display. One of the menus contains a plurality of selectable items. When one of the plurality of selectable items is selected more than a predetermined number of times, the controller displays said one of the plurality of selectable items in a menu on a higher hierarchy.

### TECHNICAL FIELD

The present invention relates to a display apparatus, which displays images and menus on its display.

### BACKGROUND OF THE INVENTION

Functions that a display apparatus provides are increasing dramatically nowadays. This has caused a dramatic increase of setting parameters users can modify. Such many parameters satisfy the demands of users who require a lot for the quality of pictures and sounds.

The setting parameters are usually changed on menus shown on the display. In a menu, there are items that correspond to the setting parameter. By selecting a specific item, the user can change the value or setting of the parameter. However, as the number of parameters that the user can change has been increasing, the number of items shown on the menu has also been increasing. This situation may make it difficult for the user to quickly find the parameter that he wants to change. In addition, to reach the parameter the user wants to change, he may have to press buttons a number of times. Such circumstances are inconvenient for the users.

Since some users are very demanding for the quality of sounds and pictures to fit their tastes, recent high-end display apparatuses need to change some parameters in detail. It would be convenient if the user can change the parameters in detail and reach their preferred setting without pressing buttons excess number of times.

### SUMMARY OF THE INVENTION

One aspect of the present invention is a display apparatus including a display and a controller. The controller displays a plurality of menus in a hierarchy order on the display. One of the menus contains a plurality of selectable items. When one of the plurality of selectable items is selected more than a predetermined number of times, the controller displays said one of the plurality of selectable items in a menu on a higher hierarchy.

Another aspect of the present invention is a display apparatus including a display and a controller. The controller displays an item and a plurality of items related to the item or a coarse gauge and a fine gauge on the display. Both of the coarse gauge and the fine gauge represents a value of a setting parameter. When a predetermined condition is not fulfilled, the controller displays the item or the coarse gauge. When the predetermined condition is fulfilled, the controller displays the plurality of items or the fine gauge.

Another aspect of the present invention is a display apparatus including a plurality of input terminals, a display and a controller. The plurality of input terminals contains a first input terminal and a second input terminal. The display selectably displays an image based on a signal originated from one of the plurality of the input terminals. The display also displays a menu for changing a setting of the display apparatus. The controller stores data of a parameter relating to the setting of the display apparatus. The data includes a first datum corresponding to the first input terminal and a second datum corresponding to the second input terminal. When the display displays an image based on a signal originated from the first input terminal, the controller adjusts the image or modifies the menu based on the first datum. When the display displays an image based on a signal originated from the second input terminal, the controller adjusts the image or modifies the menu based on the second datum.

Another aspect of the present invention is a display apparatus including a display and a controller. The controller displays a plurality of menus in a hierarchy order on the display. A menu on the highest hierarchy contains a first area, a second area and a third area. A menu on a lower hierarchy than the highest hierarchy contains a selectable item. When the selectable item is selected more than a predetermined number of times, the controller displays the selectable item in the first area of the highest hierarchy. The controller displays another item that is registered by a user in the second area of the highest hierarchy. The controller displays a preset item in the third area of the highest hierarchy.

### BRIEF DESCRIPTION OF THE DRAWINGS

FIG. 1 depicts a front view of an embodiment of a display apparatus.

FIG. 2 depicts a plan view of an example of a remote controller used for the display apparatus.

FIG. 3 depicts a plan view of terminals of the display apparatus.

FIG. 4 depicts a block diagram of the electrical components of the display apparatus.

FIG. 5 illustrates an example of a display image to explain menus of the display apparatus.

FIG. 6 illustrates an example of a display image to explain menus of the display apparatus.

FIG. 7 illustrates an example of a display image to explain menus of the display apparatus.

FIG. 8 illustrates an example of a display image to explain menus of the display apparatus.

FIG. 9 illustrates an example of a display image to explain menus of the display apparatus.

FIG. 10 illustrates an example of a display image to explain menus of the display apparatus.

FIG. 11 illustrates an example of a table used to create the menu.

FIG. 12 illustrates an example of a table used to create the menu.

FIG. 13 illustrates an example of a table used to create the menu.

FIG. 14 illustrates a flowchart describing operational steps of the display apparatus.

FIG. 15 illustrates a flowchart describing operational steps of the display apparatus.

FIG. 16 illustrates a flowchart describing operational steps of the display apparatus.

FIG. 17 illustrates a flowchart describing operational steps of the display apparatus.

FIG. 18 illustrates a flowchart describing operational steps of the display apparatus.

FIG. 19 illustrates a flowchart describing operational steps of the display apparatus.

### DETAILED DESCRIPTION OF THE INVENTION

### §1. Overview of the Display Apparatus

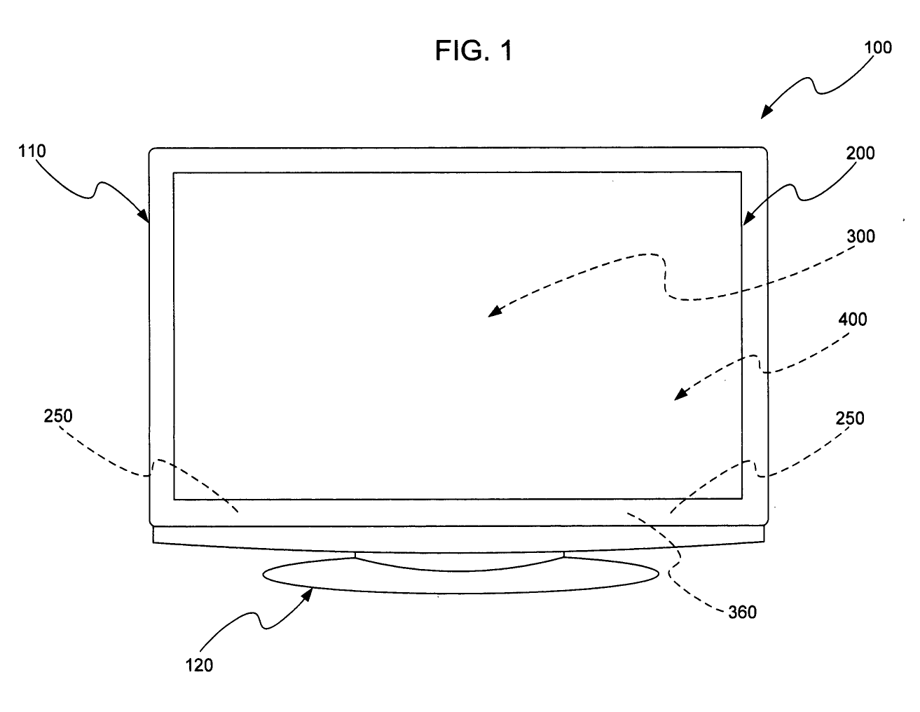

FIG. 1 shows an embodiment of a display apparatus. FIG. 1 depicts a display apparatus 100 seen from the front side of the display apparatus 100. The display apparatus 100 is a multifunctional display device. It functions as a television, a video-file player, a display device and a monitor device. Therefore, the user can use the display apparatus 100 to watch TV, videos and video files, to play video games, to operate computers and so on.

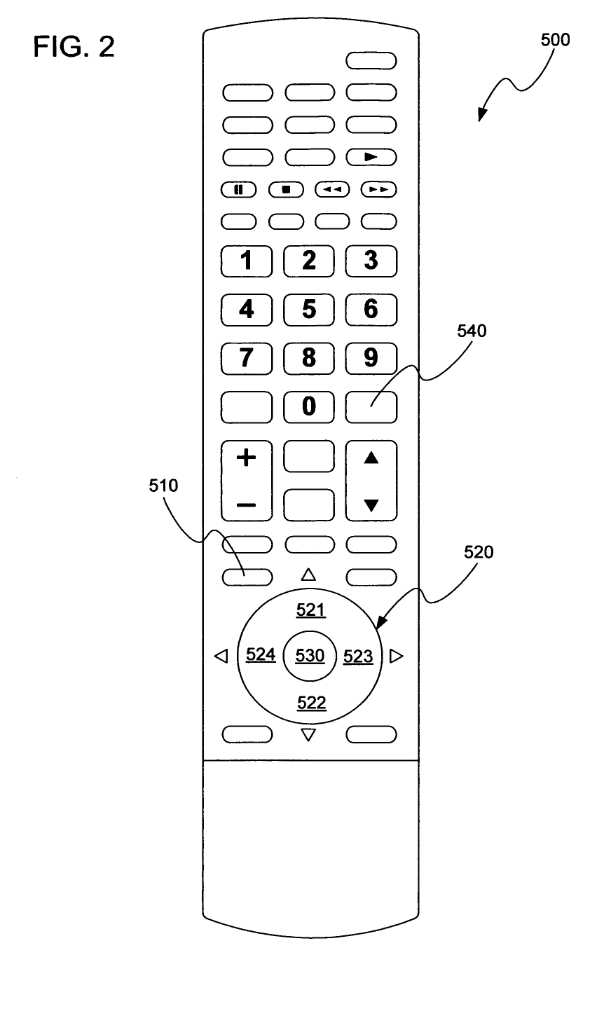

As shown in FIG. 1, the display apparatus 100 contains a body 110, a stand 120, a display 200, speakers 250, electrical components 300 and terminals 400. In addition, a remote controller 500 as shown in FIG. 2 is attached to the display apparatus 100. The basic function of the display apparatus 100 is to display an image on the display 200 based on an input signal entering one of the terminals 400.

In the display apparatus 100, the display 200 occupies a major portion of the front side of the body 110. The body 110 is physically supported by the stand 120 so that the stand 120 erects the body 110 on a flat surface. The electrical components 300 and speakers 250 are provided inside of the body 110. The terminals 400 are provided on the backside of the body 110.

The display apparatus 100 is controlled by the remote controller 500 as shown in FIG. 2. The remote controller 500 enables the user to operate the display apparatus 100 without going by the display apparatus 100. The remote controller 500 has many buttons. The buttons frequently used in this embodiment are a menu button 510, arrow buttons 520, an enter button 530 and an input button 540. The arrow buttons 520 contain an up button 521, a down button 522, a right button 523 and a left button 524.

### §2. Architecture of the Display Apparatus

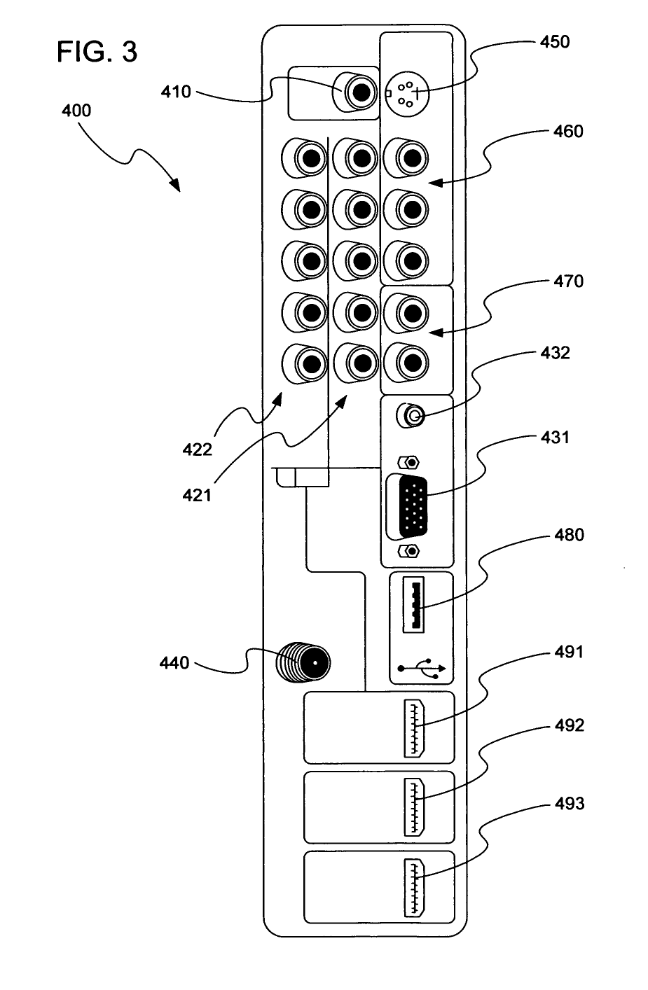

FIG. 3 shows the arrangement of the terminals 400. The terminals 400 contain various types of terminals. Thus, many kinds of video devices and sources can be connected to the display apparatus 100. The terminals 400 contain a digital audio output terminal 410, first component input terminals 421, second component input terminals 422, a PC input terminal 431, a stereo audio input terminal 432, an antenna input terminal 440, an S-video input terminal 450, composite input terminals 460, stereo audio output terminals 470, a universal serial bus (USB) port 480, a first high-definition multimedia interface (HDMI) input terminal 491, a second HDMI input terminal 492 and a third HDMI input terminal 493.

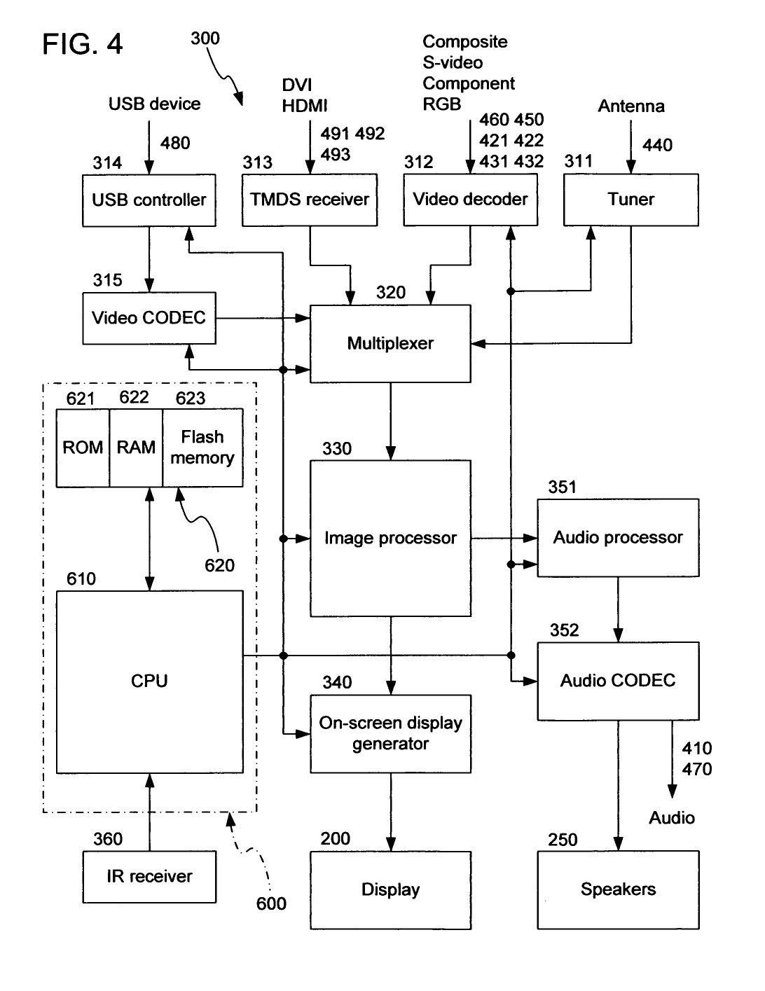

FIG. 4 shows the components of the electrical components 300. The electrical components 300 contain a tuner 311, a video decoder 312, a transition minimized differential signaling (TMDS) receiver 313, a USB controller 314, a video coder/decoder (CODEC) 315, a multiplexer 320, an image processor 330, an on-screen display generator 340, an audio processor 351, an audio CODEC 352, an infrared (IR) receiver 360, and a controller 600.

Signals from an antenna enter the multiplexer 320 through the antenna input terminal 440 and the tuner 311. Composite, S-video, component and RGB signals enter the multiplexer 320 through the composite input terminals 460, the S-video input terminal 450, the first component input terminals 421, the second component input terminals 422 or the PC input terminal 431, and the video decoder 312. Digital visual interface (DVI) and HDMI signals enter the multiplexer 320 through the first HDMI input terminal 492, the second HDMI input terminal 492 or the third HDMI input terminal 493, and the TMDS receiver 313. Video data such as mpeg and avi files from an external USB device are transmitted to the video CODEC 315 through the USB controller 314. Then, the video data are converted into video signals by the video CODEC 315 and transmitted to the multiplexer 320. One of the signals inputted into the multiplexer 320 is selected by the multiplexer 320 and transmitted to the image processor 330. The signal inputted into the image processor 330 is divided into a video signal and an audio signal. In the image processor 330, the video signal is processed to be displayed on the display 200. In addition, in the image processor 330, the video image is modified by the controller 600. The processed and modified video signal is transmitted to the on-screen display generator 340. By the on-screen display generator 340, an image signal generated by the controller 600 is overlain onto the video signal generated by the image processor 330. The overlain signal is transmitted to and displayed on the display 200. The audio signal separated by the image processor 330 is transmitted to the audio processor 351. The audio signal is modified by the audio processor 351 and transmitted to the speakers 250 or an external audio device through the audio CODEC 352.

In the display apparatus 100, a user input inputted with the remote controller 500 is transmitted to the IR receiver 360 as an infrared signal. Then, the user input signal is transmitted to the controller 600 from the IR receiver 360. Furthermore, the controller 600 can access to data in an external USB device such as a USB flash disk or a USB hard disk drive through the USB controller 314 to display files in the USB device on the display 200 and can play video files in the USB device.

The controller 600 contains a central processing unit (CPU) 610 and a memory 620. The memory 620 is composed of a read only memory (ROM) 621, a random access memory (RAM) 622 and a flash memory 623. The ROM 621 stores programs and default data sets. The RAM 622 stores temporary data. The flash memory 623 maintains data stored for a long-term. The CPU 610 controls the tuner 311, the video decoder 312, the USB controller 314, the video CODEC 315, the multiplexer 320, the image processor 330, the on-screen display generator 340, the audio processor 351 and the audio CODEC 352 based on the programs and data stored in the memory 620 and user inputs transmitted from the IR receiver 360. Furthermore, the CPU 610 generates images of menus described below and transmits the image signals to the on-screen display generator 340 to display the menus on the display 200.

### §3. Embodiments of Menus Shown on the Display

In this section, menus generated by the CPU 610 are explained.

### §3.1 Menus Shown on the Display

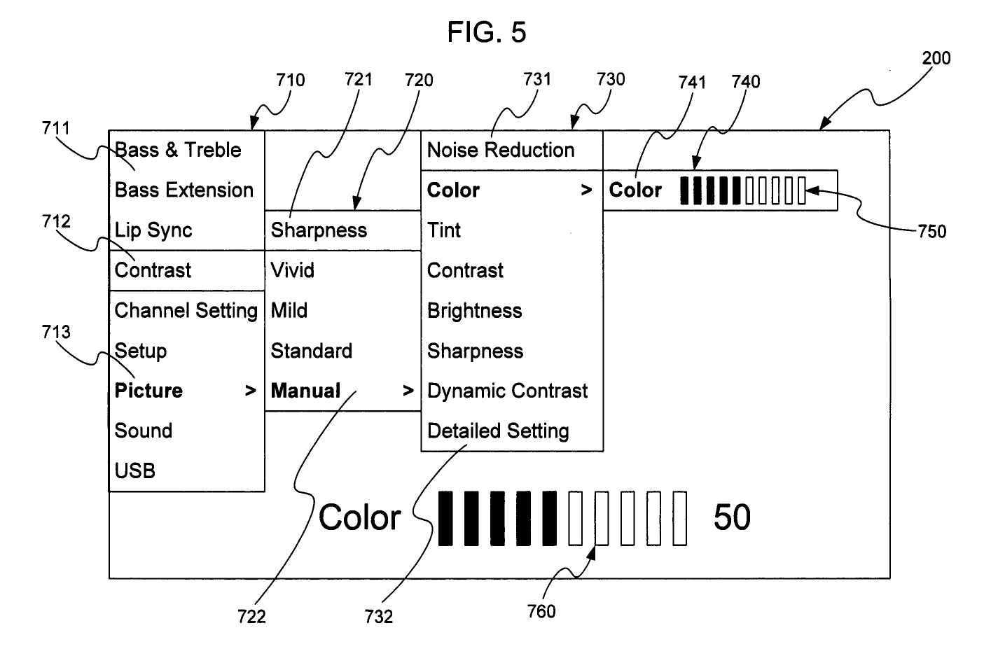

FIGS. 5-10 illustrate examples of display images generated by the CPU 610. As shown in FIG. 5, the CPU 610 can generate plural menus including a first menu 710, a second menu 720, a third menu 730 and a fourth menu 740. Each menu contains items that can be selected by a user. These items represent setting parameters of the display apparatus 100.

The menus are shown in a hierarchy order. The first menu 710 is on the highest hierarchy. The second menu 720 is on the second highest hierarchy. The third menu 730 is on the second lowest hierarchy. And, the fourth menu 740 is on the lowest hierarchy. Thus, when the user presses the menu button 510 (see FIG. 2), the first menu 710 is displayed on the display 200 first.

The first menu 710 contains three areas, a user-registered item area 711, a frequently-selected item area 712 and a default item area 713. The user-registered item area 711 shows items that are registered by the user. The frequently-selected item area 712 shows items that are frequently selected by the user. The default item area 713 shows preset items that are located in the first menu 710 from the beginning.

When one of the items in the default item area 713 is selected and the selected item contains a subcategory of items, the second menu 720 is shown on the display 200. The second menu 720 contains two areas, a frequently-selected item area 721 and a default item area 722.

Likewise, when one of the items in the default item area 722 is selected and the selected item contains a subcategory of items, the third menu 730 is shown on the display 200. The third menu 730 also contains two areas, a frequently-selected item area 731 and a default item area 732.

The fourth menu 740 contains an item/gauge area 741 where at least one item and/or one gauge is shown.

In the case of FIG. 5, after menu button 510 was pressed and the first menu 710 showed up, an item ‘Picture’ was selected by pressing the down button 522 and the right button 523 or the enter button 530. Then, the second menu 720 showed up. The default item area 722 of the second menu 720 includes the items that are subcategory of the item ‘Picture’. Then, an item ‘Manual’ was selected, and the third menu 730 showed up. In the third menu 730, an item ‘Color’ was selected, and the fourth menu 740 showed up. In the fourth menu 740, an item ‘Color’ and a color coarse gauge 750 were shown. The color coarse gauge 750 represents a value of a setting parameter ‘Color’. To make it easier for the user to see, the item ‘Color’ and the color coarse gauge 760 are also shown in the bottom of the display 200. The item ‘Color’ and the color coarse gauge 760 in the bottom of the display 200 are larger than the item ‘Color’ and the color coarse gauge 750 in the fourth menu 740. However, the color coarse gauge 750 and the color coarse gauge 760 represent the same value. By pressing the right button 523 or the left button 524, the user can change the value of the setting parameter ‘Color’.

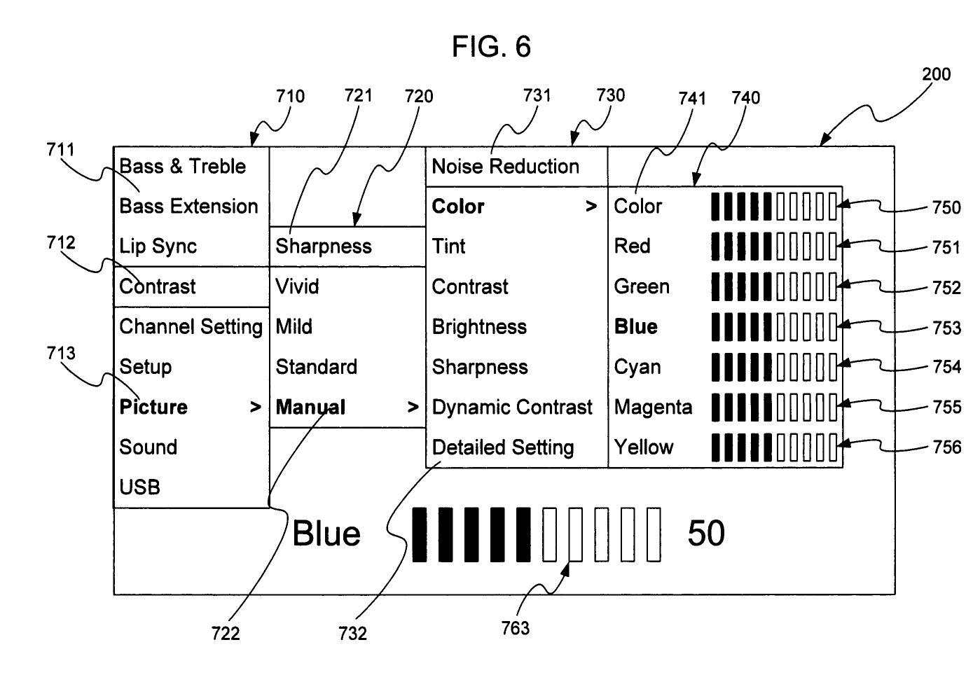

When one of the following conditions is met, the display image changes into as shown in FIG. 6.

Condition 1: When the item ‘Color’ or the color coarse gauge 750 have been displayed on the display 200 more than a predetermined number of times in a predetermined period. For example, when the item ‘Color’ and the color coarse gauge 750 have been shown on the display 200 more than five times in recent one month, the fourth menu 740 changes like FIG. 6.

Condition 2: When a parameter of the item ‘Color’, or the value of the color coarse gauge 750 have been modified more than a predetermined number of times while the item ‘Color’ and the color coarse gauge 750 have been displayed on the display 200. For example, when the value of the color coarse gauge 750 has been changed by the user more than five times while the fourth menu 740 has kept shown on the display 200, the fourth menu 740 changes like FIG. 6.

Condition 3: When the item ‘Color’ or the color coarse gauge 750 has been displayed on the display 200 for more than a predetermined period of time. For example, when the item ‘Color’ and the color coarse gauge 750 has kept shown on the display 200 for more than 10 seconds, the fourth menu 740 changes like FIG. 6.

As shown in FIGS. 5 to 6, when one of the above conditions is fulfilled, the number of items and the number of gauges increase in the fourth menu 740. Now, the fourth menu 740 contains the item ‘Color’, an item ‘Red’, an item ‘Green’, an item ‘Blue’, an item ‘Cyan’, an item ‘Magenta’, an item ‘Yellow’, the color coarse gauge 750, a red coarse gauge 751, a green coarse gauge 752, a blue coarse gauge 753, a cyan coarse gauge 754, a magenta coarse gauge 755 and a yellow coarse gauge 756.

In FIG. 6, the item ‘Blue’ is selected, and the user can change the value of the setting parameter ‘Blue’. While the blue coarse gauges 753 and 763 are displayed on the display 200, a value of the blue coarse gauges 753 and 763 are changed with a larger step. For example, when the user presses the right button 523 or the left button 524, the value of the blue coarse gauges 753 and 763 increases or decreases by a value ‘10’. Therefore, the user can change the value of the setting parameter largely without pressing buttons many times.

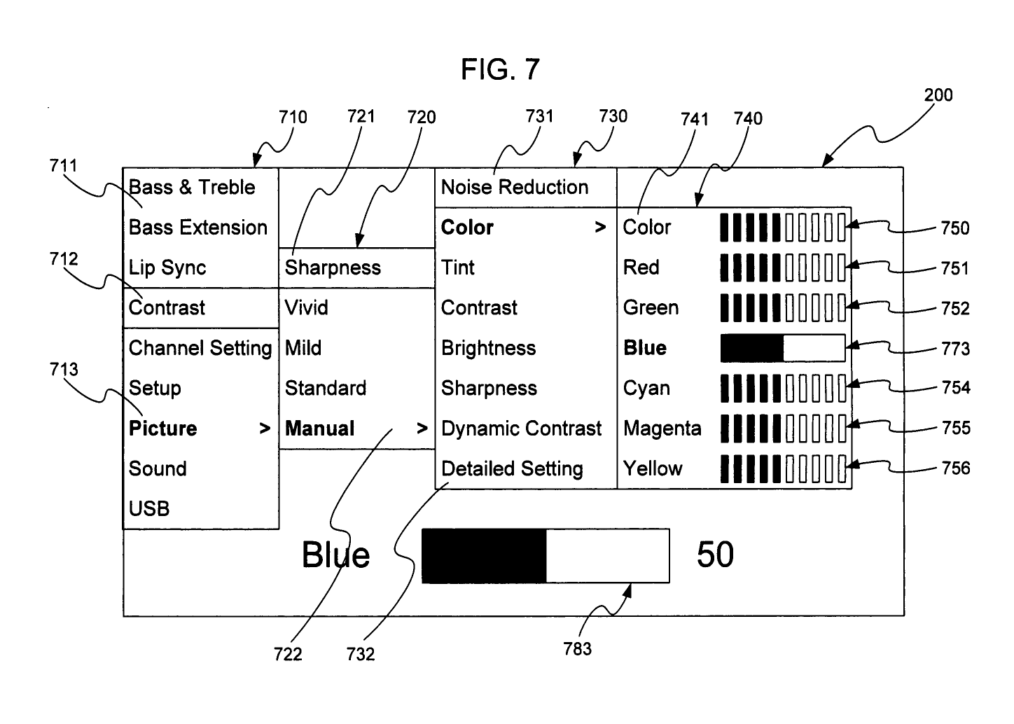

When one of the following conditions is met, the display image changes into as shown in FIG. 7.

Condition 1: When the item ‘Blue’ and the blue coarse gauge 753 have been displayed on the display 200 more than a predetermined number of times in a predetermined period. For example, when the item ‘Blue’ and the blue coarse gauges 753 and 763 have been shown on the display 200 more than five times in recent one month, the fourth menu 740 changes like FIG. 7.

Condition 2: When a parameter of the item ‘Blue’, or the value of the blue coarse gauges 753 and 763 has been modified more than a predetermined number of times while the item ‘Blue’ and the blue coarse gauges 753 and 763 have been displayed on the display 200. For example, when the value of the blue coarse gauges 753 and 763 has been changed by the user more than five times while the fourth menu 740 has kept shown on the display 200, the fourth menu 740 changes like FIG. 7.

Condition 3: When the item ‘Blue’ or the blue coarse gauges 753 and 763 have been displayed on the display 200 for more than a predetermined period of time. For example, when the item ‘Blue’ and the blue coarse gauges 753 and 763 have kept shown on the display 200 for more than 10 seconds, the fourth menu 740 changes like FIG. 7.

As shown in FIGS. 6 to 7, when one of the above conditions is fulfilled, the blue coarse gauges 753 and 763 change into blue fine gauges 773 and 783. While the blue fine gauges 773 and 783 are shown on the display 200, the value of the item ‘Blue’ is changed with a smaller step than while the blue coarse gauges 753 and 763 are shown on the display 200. For example, when the user presses the right button 523 or the left button 524, the value of the item ‘Blue’ increases or decreases by a value ‘1’. Therefore, the user can change the value of the setting parameter in detail to fit his taste.

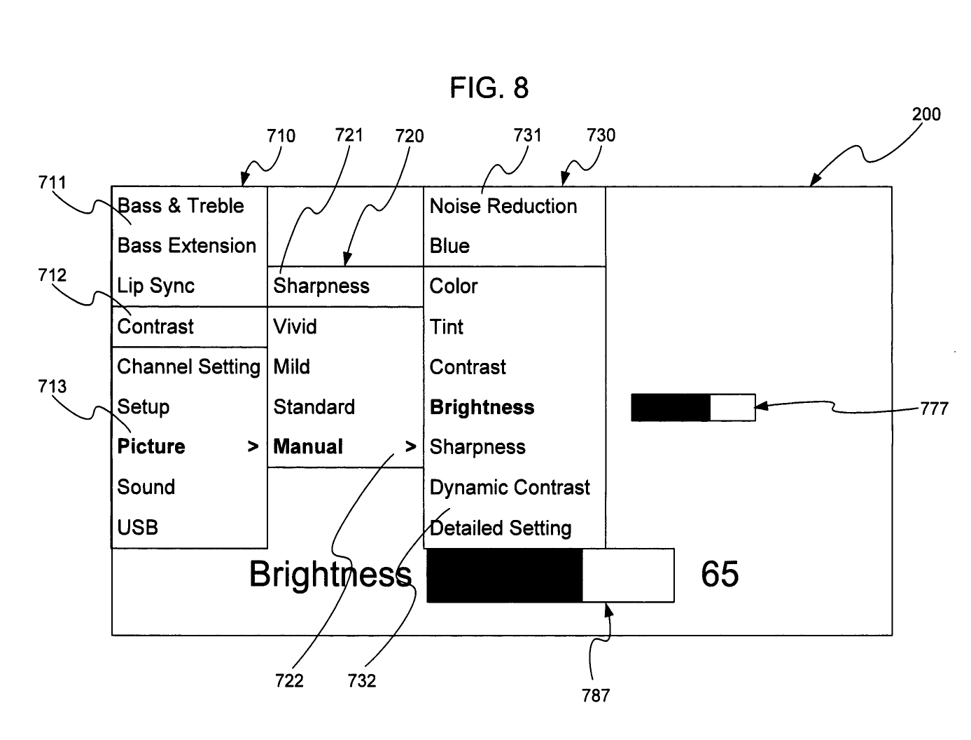

When one item is selected more than a predetermined number of times in a predetermined period, such item is displayed in a menu on a higher hierarchy. For example, as shown in FIGS. 7 to 8, when the item ‘Blue’ in the fourth menu 740 has been selected more than twice in a month, the item ‘Blue’ is also displayed in the frequently-selected item area 731 of the third menu 730. Likewise, when the item ‘Blue’ has been selected more than five times in a month, the item ‘Blue’ will be displayed in the frequently-selected item area 721 of the second menu 720 instead of the frequently-selected item area 731. Furthermore, when the item ‘Blue’ has been selected more than nine times in a month, the item ‘Blue’ will be displayed in the frequently-selected item area 712 of the first menu 710 instead of the frequently-selected item area 721.

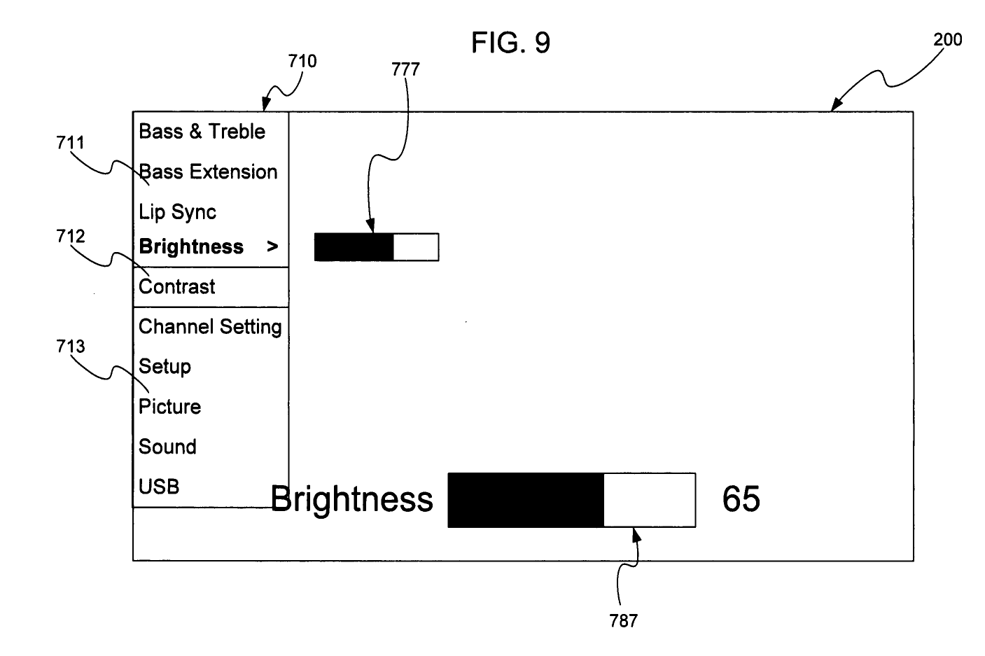

In the display apparatus 100, the user can register an item that the user wants to see in the first menu 710. For example, when the user wants to register an item ‘Brightness’ in the third menu 730, the user selects the item ‘Brightness’ and hold the enter button 530 for a certain period of time such as five seconds. Then, as shown in FIGS. 8 to 9, the item ‘Brightness’ is registered and shown in the user-registered item area 711 in the first menu 710. When the item ‘Brightness’ in the first menu 710 is selected by the user, a brightness fine gauges 777 and 787 are displayed on the display 200. Now, the user can change a value of the item ‘Brightness’ in the first menu 710.

The user can also delete the registered item from the user-registered item area 711. For example, when the user wants to delete the item ‘Brightness’ from the user-registered item area 711, the user selects the item ‘Brightness’ and hold the enter button 530 for a certain period of time such as five seconds. Then, the display image goes back as shown in FIG. 8. The item ‘Brightness’ has been deleted from the user-registered item area 711 and is shown only in the third menu 730.

Likewise, the user can delete the items in the frequently-selected item areas 712, 721 and 731. For example, when the user wants to delete the item ‘Blue’ from the frequently-selected item area 731, the user selects the item ‘Blue’ and hold the enter button 530 for a certain period of time such as five seconds. Then, the display image goes back as shown in FIG. 7. The item ‘Blue’ has been deleted from the frequently-selected item area 731 and is shown only in the fourth menu 740.

In the display apparatus 100, the data and values related to items, parameters and gauges are stored independently based on the input terminals, which are the first component input terminals 421, the second component input terminals 422, the PC input terminal 431, the antenna input terminal 440, the S-video input terminal 450, the composite input terminals 460, the USB port 480, the first HDMI input terminal 491, the second HDMI input terminal 492 and the third HDMI input terminal 493. The display images shown in FIGS. 5-9 are examples of when the signal input is selected to be the first HDMI input terminal 491.

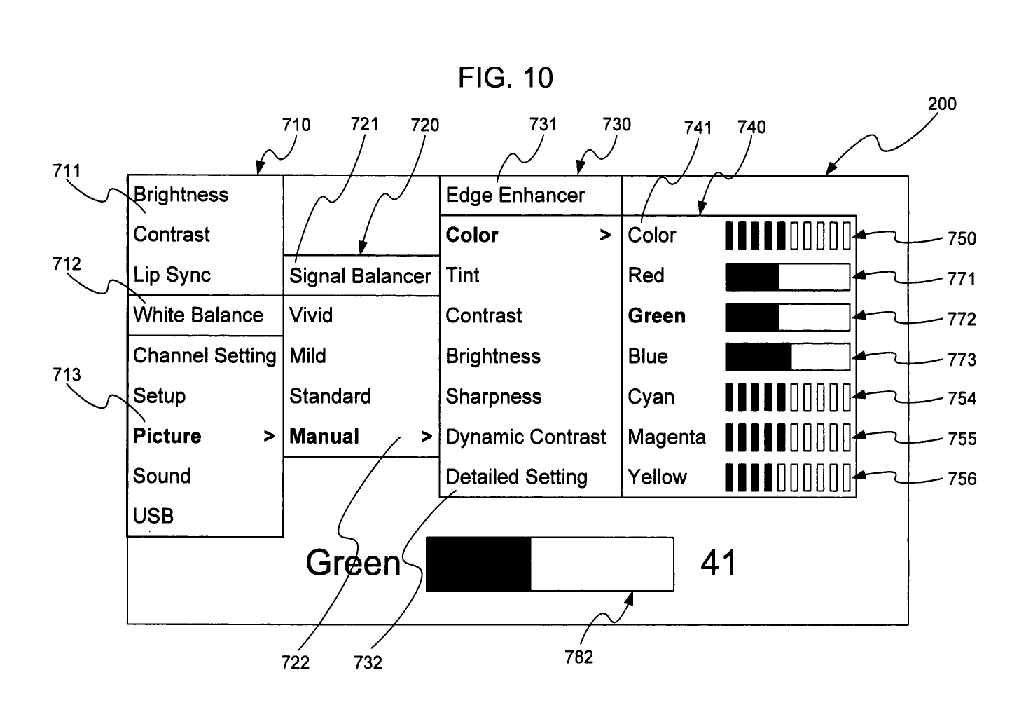

If the signal input is selected to be the antenna by pressing the input button 540, the display image can change like FIG. 10. In the display apparatus 100, the memory 620 stores data of the number of times associated with the items selected during a predetermined period of time based on the input terminals. Thus, the CPU 610 generates different menus 710-740 based on the number of items selected by the user for each input terminal. In FIG. 10, items shown in the frequently-selected item areas 712, 721 and 731 are different from those shown in FIGS. 5-9. Whether the gauges are coarse gauges or fine gauges is also different from that in FIGS. 5-9. Furthermore, the number of items shown in the fourth menu 740 can be different too.

In addition to the number of times associated with the items having been selected, the memory 620 stores data of the items registered by the user separately based on the input terminals. Therefore, items shown in the user-registered item area 711 are different between when the display 200 shows an image based on the input signal from the first HDMI input terminal 491 and when the display 200 shows an image based on the input signal from the antenna input terminal 440. In other word, items registered while the display 200 showed an image based on the input signal from the first HDMI input terminal 491 are shown in the user-registered item area 711 only while the display 200 is showing an image based on the input signal from the first HDMI input terminal 491. Likewise, items registered while the display 200 showed an image based on the antenna input terminal 440 are shown in the user-registered item area 711 only while the display 200 is showing an image based on the input signal from the antenna input terminal 440.

Furthermore, the memory 620 stores data of the values on pictures and sounds separately based on the input terminals. Thus, when the display apparatus 100 displays an image based on the first HDMI input, the controller 600 modifies the image based on the data set for the first HDMI input. Likewise, when the display apparatus 100 displays an image based on the antenna input, the controller 600 modifies the image based on the data set for the antenna input. In short, the values of the setting parameters for the display apparatus 100 are independent based on the input source. In other word, when the user changes the input source, the displayed image is modified based on the values of the setting parameters for that input source. In FIG. 10, the CPU 610 has restored the values for the antenna input that are stored in the memory 620, and the display 200 shows the values of parameters in the color coarse gauge 750, the red fine gauge 771, the green fine gauge 772, the blue fine gauge 773, the cyan coarse gauge 754, the magenta coarse gauge 755 and the yellow coarse gauge 756 based on the restored values. The sounds and pictures generated on the display 200 and the speaker 250 are modified based on these restored values.

§3.2 Advantage of this Embodiment

In this embodiment, the menu on the highest hierarchy, which is the first menu 710, contains the user-registered item area 711 the frequently-selected item area 712 and the default item area 713. Such arrangement makes it unnecessary for the user to go to a menu on a deeper hierarchy to select some items. Thus such arrangement can reduce the number of buttons that the user presses to reach the item of which the user wants to change the parameter.

In this embodiment, when a predetermined condition is not fulfilled, the controller 600 displays one item ‘Color’ in the fourth menu 740 while the controller 600 displays plural items in the fourth menu 740 when the predetermined condition is fulfilled. This makes the menu simple in the beginning and prevents the user from being overwhelmed by excess number of items.

The one item ‘Color’ and the plural items related to the item ‘Color’ are displayed in the same menu. Such arrangement makes it easy for the user to understand the relation of the one item and the other plural items.

Likewise, when a predetermined condition is not fulfilled, the controller 600 displays a coarse gauge in a menu while the controller 600 displays a fine gauge in the same menu when the predetermined condition is fulfilled. This enables the user to change a value of a parameter by large amount with pressing a fewer number of buttons in the beginning. After that, the user can change the value of the parameter in detail to fit to their taste.

Since the appearance of the fine gauge is different from the appearance of the coarse gauge, the user can intuitively recognize that he can change the parameter by a different step.

However, width and length of the fine gauge are substantially equal to width and length of the coarse gauge respectively. In addition, the coarse gauge and the fine gauge are displayed almost at the same position. By this arrangement, the user can easily understand that the user is still setting the same parameter of an item even after the appearance of the gauge has changed.

In this embodiment, one selectable item such as the item ‘Blue’ is in a menu on a lower hierarchy than the highest hierarchy, such as the fourth menu 740. When the selectable item is selected more than a predetermined time in a predetermined period, the selectable item is displayed in a menu on a higher hierarchy such as the third menu 730. Such arrangement reduces the number of buttons the user presses to reach the item the user frequently uses.

As the frequency that the user selects an item increases, the item moves to menus on a higher hierarchy step by step. For example, when the item ‘Blue’ is selected equal to or less than a first predetermined number of times, the controller 600 displays the item ‘Blue’ in a menu on a default hierarchy, which is the fourth menu 740. When the item ‘Blue’ is selected more than a first predetermined number of times, the controller 600 displays the item ‘Blue’ in a second menu on a higher hierarchy than the default hierarchy, which is the third menu 730. When the item ‘Blue’ is selected more than a second predetermined number of times, the controller 600 displays the item ‘Blue’ in a third menu on a higher hierarchy than the hierarchy of the second menu, which is the second menu 720. Such arrangement reduces the number of buttons the user presses to reach the item the user frequently uses without making a specific menu overcrowded.

The items shown in the user-registered item area 711, frequently-selected item areas 712, 721 and 731 can be deleted by the user. This enables the user to see only the items that user wants to see in the menus on higher hierarchies.

In this embodiment, the controller 600 stores data of a parameter that is related to the setting of the display apparatus 100 independently based on the input terminals. When the display 200 displays an image based on a signal originated from one input terminal, the controller 600 adjusts the image and sound or modifies the menu based on the data for this input terminal. When the display 200 displays an image based on a signal originated from other input terminal, the controller 600 adjusts the image and sound or modifies the menu based on the datum for this other input terminal. The user may have different preferred settings on images and sounds for watching TV, videos and video files, for playing video games, and for operating a computer. The display apparatus 100 reproduces such settings based on the signal input. Therefore, the user doesn't have to set the parameter again to fit to his preference for that input after the user changes the input sources.

Besides, menus created on the display 200 are different based on the input signals from which the display 200 shows the image. The parameters of items the user frequently changes may be different when the user plays a video game and when the user plays video files from a USB flash disk. On the display apparatus 100, the user can easily reach the items he wants to change after he changes the input sources.

### §3.3 Other Embodiments

In the above embodiment, when a selectable item was selected more than a predetermined number of times in a predetermined period, the controller 600 displayed the item in a menu on a higher hierarchy. However, in other embodiment, when a selectable item is selected just more than a predetermined number of times, the controller 600 may display the item in a menu on a higher hierarchy without taking an account of a period of time.

In the above embodiment, when a selectable item or a coarse gauge has been modified more than a predetermined number of times while such item or the gauge has been displayed on the display 200, the number of items shown increased or the coarse gauge changed into the fine gauge. However, in other embodiments, the number of items shown may increase or the coarse gauge may change into the fine gauge when a selectable item or a coarse gauge has been modified more than a predetermined number of times while at least one of the first menu 710, the second menu 720, the third menu 730 or the fourth menu 740 has been displayed on the display 200.

In the above embodiment, after a selectable item or a coarse gauge has been displayed on the display 200 for more than a predetermined period of time, the number of items shown increased or the coarse gauge changed into the fine gauge. However, in other embodiments, the number of items shown may increase or the coarse gauge may change into the fine gauge after at least one of the first menu 710, the second menu 720, the third menu 730 or the fourth menu 740 has been displayed on the display 200 for more than a predetermined period of time.

In the above embodiment, the menus on higher hierarchies kept shown on the display 200 after a menu on a lower hierarchy was shown. For example, the first menu 710 kept shown after the second menu 720 showed up. In other embodiment, the menu on a higher hierarchy may disappear when a menu on a lower hierarchy shows up.

In the above embodiment, colors and brightness were used as examples of setting parameters of image (picture). However the other embodiments can include tint, contrast, sharpness, dynamic contrast, signal balancer, noise reduction, white balance, vertical sharpness, edge enhancer, horizontal size, vertical size and so on as the setting parameters of image. Furthermore, the setting parameters of the display apparatus 100 are not limited to the parameters of image. In other embodiment, the setting parameters may include the parameter of sound or anything else. The setting parameters of sound may include bass & treble, bass extension, lip sync, audyssey dynamic volume, 4-band equalizer and so on.

In the above embodiment, the display apparatus 100 played video files in the external USB devices through the USB port 480 and the video CODEC 315. In other embodiments, the display apparatus 100 may display pictures of picture files such as jpeg files or tiff files. In other embodiments, the display apparatus 100 may play music of sound files such as mp3 or wave files.

In the above embodiment, items shown in the menus were about setting parameters of the display apparatus 100. In other embodiment, the items in the menu may be files stored in a USB device connected to the USB port 480.

In the above embodiment, the controller 600 was constituted with the CPU 610 and the memory 620. In other embodiments, the controller 600 may be constituted with other type of processors or electrical devices.

### §4. Operation of the Display Apparatus

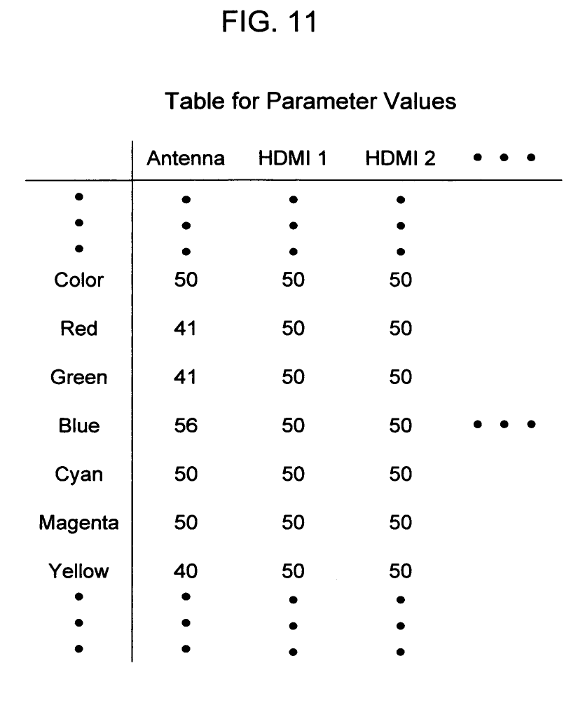

In this section, operation of the display apparatus is explained with FIGS. 11-19.

### §4.1 Data Table Used for the Operation

The controller 600 stores tables for items shown in the default item areas 713, 722, 732 and the fourth menu 740 in the ROM 621. The controller 600 also stores tables for default values of setting parameters in the ROM 621.

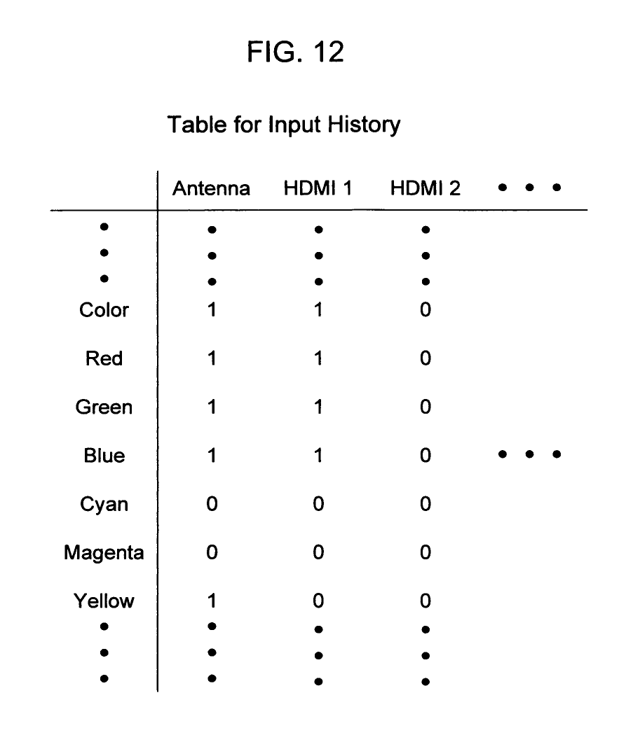

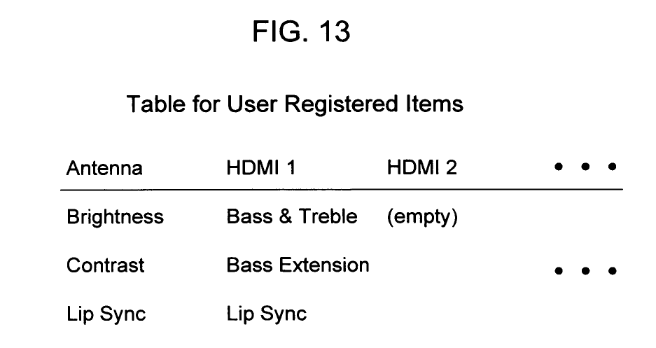

The tables shown in FIGS. 11-13 are stored in the flash memory 623. Thus, these data are stored for a long term and not lost during a power failure of the display apparatus 100. Such data include values of parameters on items (FIG. 11), values of numbers of times of the items which have been selected in recent one month (input history in FIG. 12), and items registered by the user (FIG. 13). As shown in FIGS. 11 to 13, the values of parameters on items, the values of numbers of times of the items which have been selected in recent one month, and items registered by the user are stored independently based on the input terminals.

The controller 600 generates temporary data of tables corresponding to the items displayed in the frequently-selected item areas 712, 721 and 731 in the RAM 622.

### §4.2 Operation of the Display Apparatus

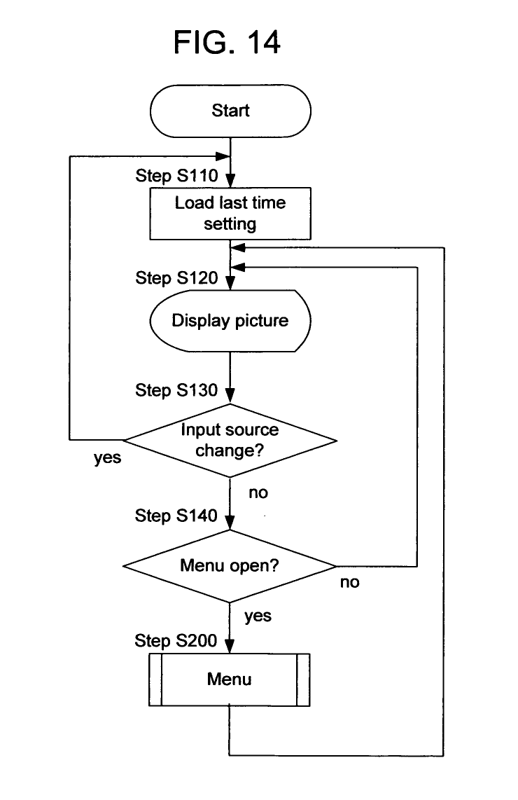

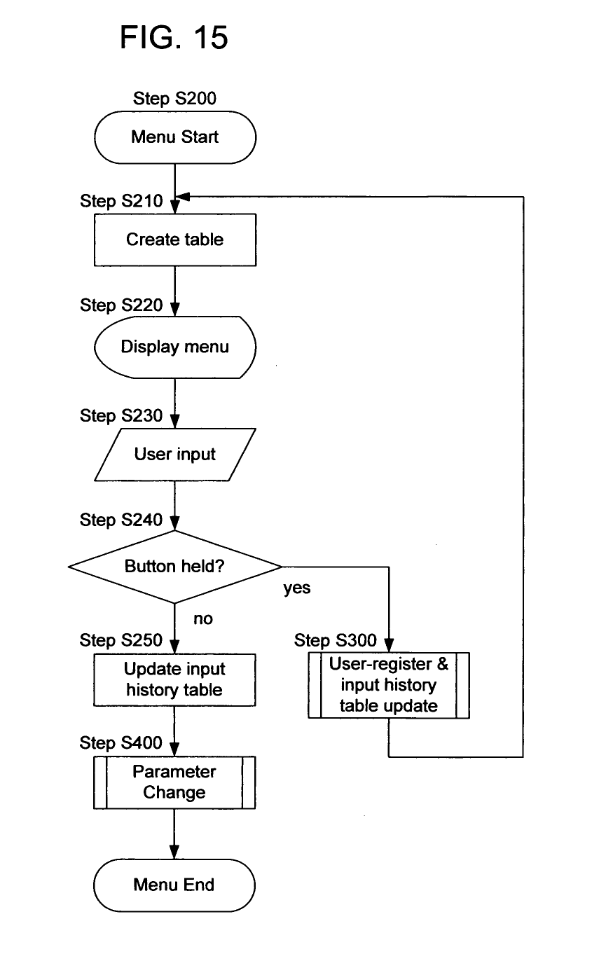

Below, operation of the display apparatus is explained with FIGS. 14-19. First, main routines are explained based on FIG. 14. It is assumed that the turning on the display apparatus 100 initiates the first step of the operation.

<Step S110> The CPU 610 loads the values of the setting parameters from the flash memory 623. More specifically, the CPU 610 reads a value set corresponding to the input source from which the display apparatus 100 generates an image. For example, when the display apparatus 100 is showing an image based on an input signal from the first HDMI input terminal 491, the CPU 610 reads the values for ‘HDMI 1’ as referred in FIG. 11.

<Step S120> The display apparatus 100 displays an image on the display 200, modifying the image based on the values read in the previous step.

<Step S130> The CPU 610 determines whether the input source is changed, or the input button 540 is pressed. If the input source is changed, the process goes back to the Step S110. In the second round of Step S110, if the user has selected to show a picture from the antenna, in other word, if the display apparatus 100 is showing an image based on an input signal from the antenna input terminal 440, the CPU 610 reads the values for ‘Antenna’ as referred in FIG. 11. If the input source is not changed, the process proceeds to the next step.

<Step S140> The CPU 610 determines whether the menu button 510 is pressed. If the menu button 510 is pressed, the process proceeds to the Menu Step S200. If the menu button 510 is not pressed, the process goes back to the Step S120.

<Step S200> As shown in FIG. 15, the Menu Step S200 is composed of Steps S210-S250, S300 and S400.

<Step S210> The CPU 610 creates tables for items shown in the menus based on the tables stored in the memory 620. The items in the tables created in this step correspond to the items shown in the menus on the display 200. The tables are created based on the table of the items registered by the user (FIG. 13), the table of the input history (FIG. 12), and the tables for default items shown in the default item areas 713, 722, 732 and the fourth menu 740. The table of the items registered by the user brings items shown in the user-registered item area 711. The table of the input history brings items shown in the frequently-selected item areas 712, 721 and 731. For example, when an item has been selected more than twice and less than six times in a month, this item is put in the table for the third menu 730. If the item has been selected more than five times and less than ten times in a month, this item is put in the table for the second menu 720. If the item has been selected more than nine times in a month, this item is put in the table for the first menu 710. The tables of the default items bring the items shown in the default item areas 713, 722, 732 and the fourth menu 740.

<Step S220> The CPU 610 displays menus on the display 200 based on the tables created in the previous step.

<Step S230> The CPU 610 receives user inputs for an item in the menu.

<Step S240> The CPU 610 determines whether the enter button 530 is held for a certain period of time such as five seconds. If the enter button 530 is held for a certain period of time, the process jumps to User-Register & Input History Table Update Step S300. If the enter button 530 is held for less than five seconds, the process proceeds to Step S250.

<Step S250> The CPU 610 updates the table of user input history. For example, if the item ‘Blue’ is selected by the user while the display 200 is showing an image from an input signal from the first HDMI input terminal 491, the CPU 610 increments the value corresponding to the item ‘Blue’ in the data set of HDMI 1 in FIG. 12. Then, the process jumps to Parameter Change Step S400.

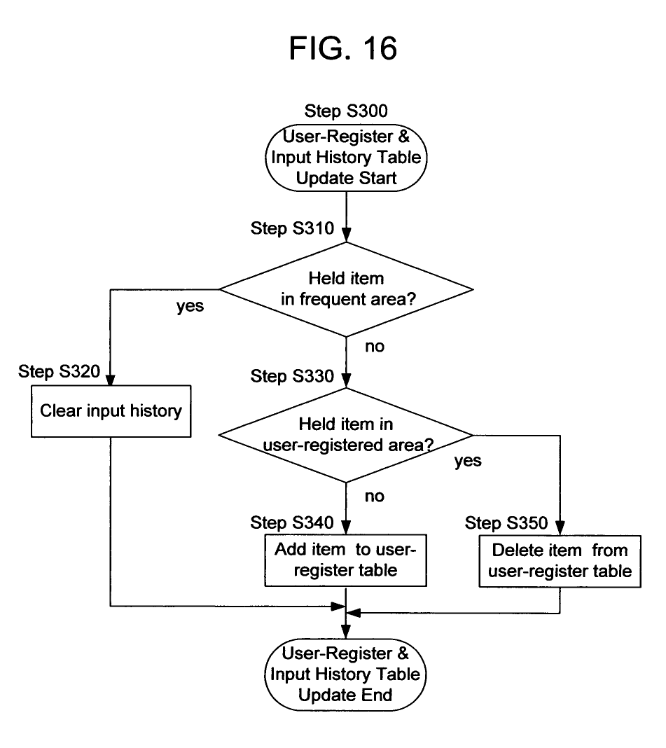

After the Menu Step S200 is done, the process goes back to the Step S120.

<Step S300> As shown in FIG. 16, the User-Register & Input History Table Update Step S300 is composed of Steps S310-S350.

<Step S310> The CPU 610 determines whether the item selected by the user is in the frequently-selected item area 712, 721 or 731. If the item selected by the user is in the frequently-selected item area 712, 721 or 731, the process branches to Step S320. If the item selected by the user is not in the frequently-selected item area 712, 721 or 731, the process goes to Step S330.

<Step S320> The CPU 610 clears a value of the number of times of the items which have been selected in recent one month of the item selected currently in the Table for Input History (FIG. 12). For example, if the item ‘Blue’ in the frequently-selected item area 731 in FIG. 8 is held by the user while the display 200 is displaying an image based on the first HDMI input, the CPU 610 clears the value of the item ‘Blue’ in the HDMI 1 column in the Table for Input History. Thereby, the item ‘Blue’ is erased from the frequently-selected item area 731 as shown in FIG. 7. Then, the operation terminates the User-Register & Input History Table Update Step S300.

<Step S330> The CPU 610 determines whether the item selected by the user is in the user-registered item area 711. If the item selected by the user is not in the user-registered item area 711, the process proceeds to Step S340. If the item selected by the user is in the user-registered item area 711, the process branches to Step S350.

<Step S340> The CPU 610 adds the selected item in the Table for User Registered Item (FIG. 13). For example, if the item ‘Brightness’ in the default item area 732 in FIG. 8 is held by the user while the display 200 is displaying an image based on the first HDMI input, the CPU 610 adds the item ‘Brightness’ in the HDMI 1 column in the Table for User Registered Item. Thereby, the item ‘Brightness’ is added in the user-registered item area 711 as shown in FIG. 9. Then, the operation terminates the User-Register & Input History Table Update Step S300.

<Step S350> The CPU 610 deletes the selected item from the Table for User Registered Item. For example, if the item ‘Brightness’ in the user-registered item area 711 in FIG. 9 is held by the user while the display 200 is displaying an image based on the first HDMI input, the CPU 610 erases the item ‘Brightness’ in the HDMI 1 column in the Table for User Registered Item. Thereby, the item ‘Brightness’ is deleted from the user-registered item area 711 as shown in FIG. 8. Then, the operation terminates the User-Register & Input History Table Update Step S300.

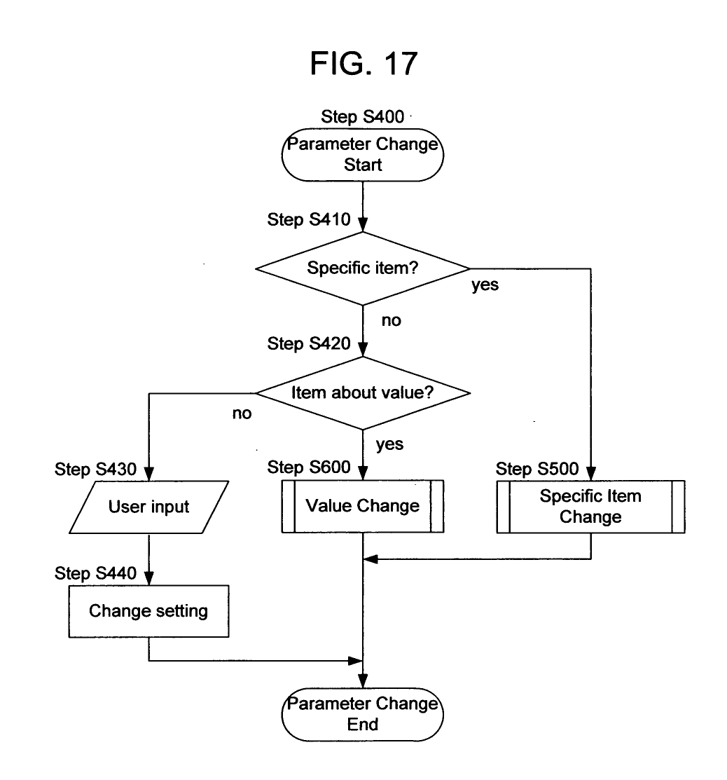

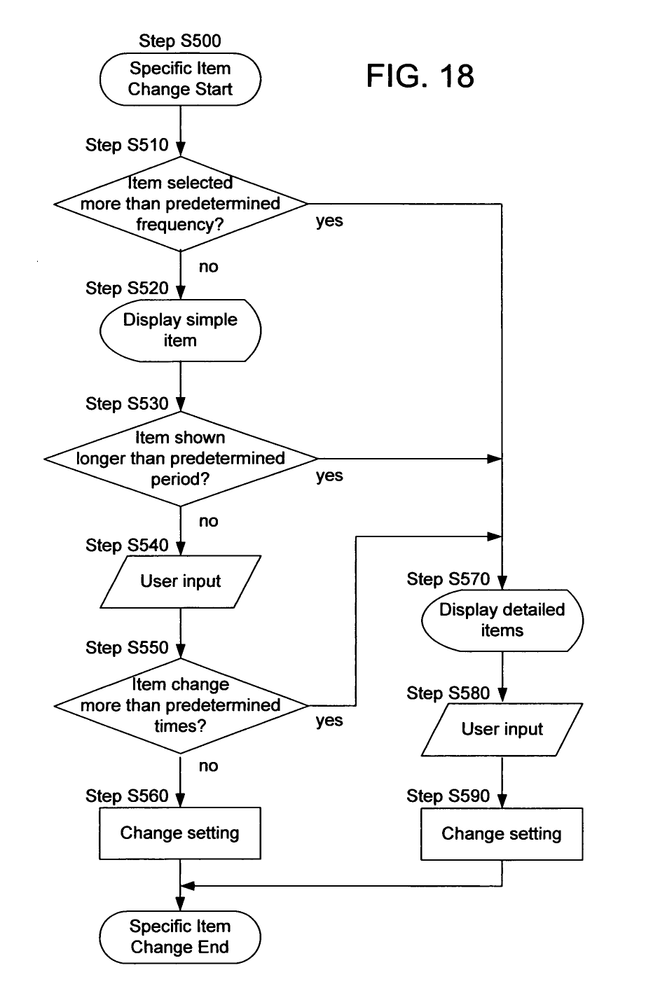

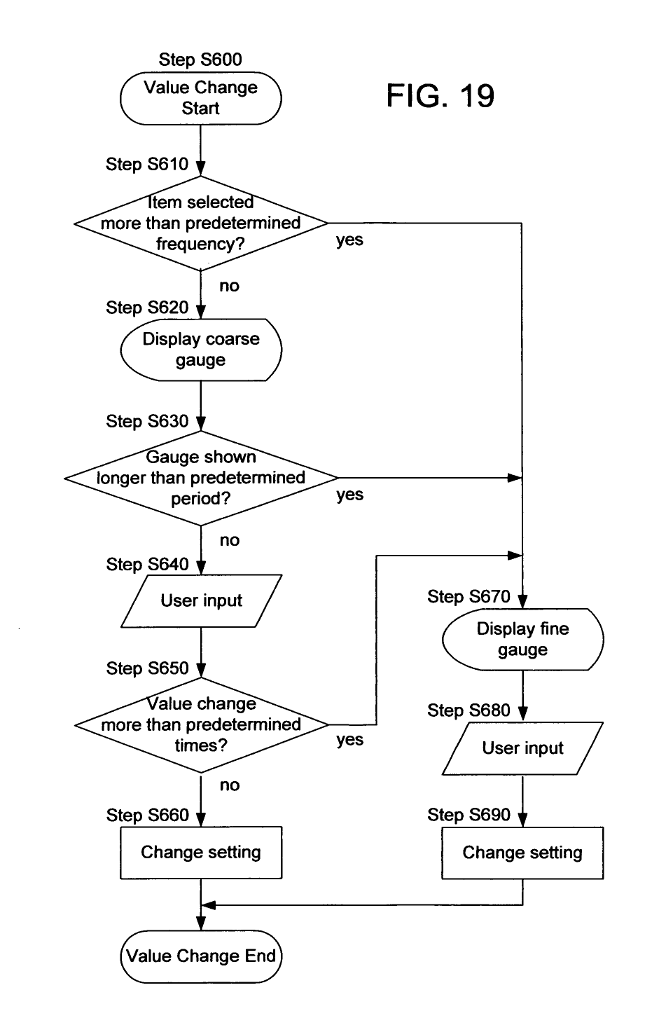

After the User-Register & Input History Table Update Step S300 is done, the process goes back to the Step S210.

<Step S400> As shown in FIG. 17, the Parameter Change Step S400 is composed of Steps S410-S440, S500 and S600.

<Step S410> The CPU 610 determines whether the item selected by the user is a specific item such as the item ‘Color’. If the selected item is the specific item, the process jumps to Specific Item Change Step S500. Otherwise, the process proceeds to Step S420.

<Step S420> The CPU 610 determines whether the item selected by the user relates to a value such as the item ‘Blue’. If the selected item relates to a value, the process jumps to Value Change Step S600. If the selected item does not relates to a value such as stereo sound/monaural sound, the process proceeds to Step S430.

<Steps S430 & S440> The CPU 610 receives a user input and changes the setting of parameter based on this user input. Then, the operation terminates the Parameter Change Step S400.

<Step S500> As shown in FIG. 18, the Specific Item Change Step S500 is composed of Steps S510-S590.

<Step S510> The CPU 610 determines whether the item selected by the user has been shown in the display 200 in more than a predetermined frequency. In other words, the CPU 610 determines whether the selected item has been displayed on the display 200 more than a predetermined number of times in a predetermined period. For example, when the item ‘Color’ is selected by the user as shown in FIG. 5, the CPU 610 determines whether the item ‘Color’ has been shown on the display 200 more than five times in recent one month by referring to the Table for Input History (FIG. 12). If the selected item has been displayed on the display 200 more than a predetermined number of times in a predetermined period, the process branches to Step S570. Otherwise, the process proceeds to Step S520.

<Step S520> The CPU 610 displays a simple item on the display 200. For example, the CPU 610 shows just one item ‘Color’ in the fourth menu 740 as shown if FIG. 5.

<Step S530> The CPU 610 determines whether the item selected by the user has been shown in the display 200 for more than a predetermined period of time. For example, the CPU 610 determines whether the item ‘Color’ and the color coarse gauge 750 have kept shown on the display 200 for more than 10 seconds. If the selected item has been shown in the display 200 for more than a predetermined period of time, the process branches to Step S570. Otherwise, the process proceeds to Step S540.

<Step S540> The CPU 610 receives a user input through the remote controller 500.

<Step S550> The CPU 610 determines whether a parameter of the item has been modified more than a predetermined number of times. For example, the CPU 610 determines whether the parameter of the item ‘Color’ has been changed by the user more than five times while the item ‘Color’ and the color coarse gauge 750 is kept shown on the display 200. If the parameter of the item has been modified more than a predetermined number of times, the process branches to Step S570. Otherwise, the process proceeds to Step S560.

<Step S560> The CPU 610 changes the setting of the display apparatus 100 based on the user input. Then, the operation terminates the Specific Item Change Step S500.

<Step S570> The CPU 610 displays detailed items related to the simple items on the display 200. For example, as shown in FIG. 6, the CPU 610 shows the items ‘Red’, ‘Green’, ‘Blue’, ‘Cyan’, ‘Magenta’, and ‘Yellow’ in the fourth menu 740, all of which are related to the item ‘Color’.

<Steps S580 & S590> The CPU 610 receives a user input through the remote controller 500. Then, the CPU 610 changes the setting of the display apparatus 100 based on this user input. Then, the operation terminates the Specific Item Change Step S500.

<Step S600> As shown in FIG. 19, the Value Change Step S600 is composed of Steps S610-S690.

<Step S610> The CPU 610 determines whether the item selected by the user and the gauge related to this item have been shown in the display 200 in more than a predetermined frequency. In other words, the CPU 610 determines whether the selected item or gauge has been displayed on the display 200 more than a predetermined number of times in a predetermined period. For example, when the item ‘Blue’ and the blue coarse gauge 753 is selected by the user as shown in FIG. 6, the CPU 610 determines whether the item ‘Blue’ and the blue coarse gauge 753 have been shown on the display 200 more than five times in recent one month, referring the Table for Input History (FIG. 12). If the selected item and the gauge have been displayed on the display 200 more than a predetermined number of times in a predetermined period, the process branches to Step S670. Otherwise, the process proceeds to Step S620.

<Step S620> The CPU 610 displays a coarse gauge on the display 200. For example, the CPU 610 shows the blue coarse gauge 753 in the fourth menu 740 as shown in FIG. 6.

<Step S630> The CPU 610 determines whether the gauge has been shown in the display 200 for more than a predetermined period of time. For example, the CPU 610 determines whether the blue coarse gauge 753 has been kept shown on the display 200 for more than 10 seconds. If the gauge has been shown in the display 200 for more than a predetermined period of time, the process branches to Step S670. Otherwise, the process proceeds to Step S640.

<Step S640> The CPU 610 receives a user input through the remote controller 500.

<Step S650> The CPU 610 determines whether the value of the coarse gauge has been changed more than a predetermined number of times. For example, the CPU 610 determines whether the value of the blue coarse gauge 753 has been changed by the user more than five times while the blue coarse gauge 753 is kept shown on the display 200. If the value of the coarse gauge has been changed more than a predetermined number of times, the process branches to Step S670. Otherwise, the process proceeds to Step S660.

<Step S660> The CPU 610 changes the value of the parameter of the item based on the user input. Then, the operation terminates the Value Change Step S600.

<Step S670> The CPU 610 displays a fine gauge on the display 200. For example, as shown in FIG. 7, the CPU 610 shows the blue fine gauge 773 in the fourth menu 740.

<Steps S680 & S690> The CPU 610 receives a user input through the remote controller 500. Then, the CPU 610 changes the value of the parameter of the item based on this user input. Then, the operation terminates the Value Change Step S600.

What is claimed is:

1. A display apparatus comprising:
a display, and
a controller for displaying a plurality of menus in a hierarchy order on the display, one of the menus containing a plurality of selectable items;
wherein when one of the plurality of selectable items is selected more than a predetermined number of times, the controller displays said one of the plurality of selectable items in a menu on a higher hierarchy.

2. The display apparatus of claim 1, wherein when one of the plurality of selectable items is selected more than the predetermined number of times in a predetermined period, the controller displays said one of the plurality of selectable items in a menu on a higher hierarchy.

3. The display apparatus of claim 1, wherein the controller displays at least three menus in a hierarchy order on the display, and
wherein when one of the plurality of selectable items is selected equal to or less than a first predetermined number of times, the controller displays said one of the plurality of selectable items in a menu on a default hierarchy,
wherein when one of the plurality of selectable items is selected more than a first predetermined number of times, the controller displays said one of the plurality of selectable items in a second menu on a higher hierarchy than the default hierarchy, and
wherein when one of the plurality of selectable items is selected more than a second predetermined number of times, the controller displays said one of the plurality of selectable items in a third menu on a higher hierarchy than the hierarchy of the second menu.

4. The display apparatus of claim 1, wherein when one of the plurality of selectable items is selected more than the predetermined number of times, the controller displays said one of the plurality of selectable items in a menu on a highest hierarchy.

5. The display apparatus of claim 1, wherein the controller displays an item that is registered by a user in a menu.

6. The display apparatus of claim 5, wherein the controller deletes said one of the plurality of selectable items or an item that is registered by the user from a menu on a higher hierarchy than a default hierarchy based on a user input.

7. The display apparatus of claim 1, wherein the controller displays an item that is registered by a user in a menu on a highest hierarchy.

8. The display apparatus of claim 7, wherein the controller displays said one of the plurality of selectable items, the item that is registered by the user, and a preset item in a menu on the highest hierarchy.

9. A display apparatus comprising:
a display, and
a controller for displaying an item and a plurality of items related to the item or a coarse gauge and a fine gauge on the display, both of the coarse gauge and the fine gauge representing a value of a setting parameter;
wherein when a predetermined condition is not fulfilled, the controller displays the item or the coarse gauge; and
wherein when the predetermined condition is fulfilled, the controller displays the plurality of items or the fine gauge.

10. The display apparatus of claim 9, wherein the predetermined condition is whether the item or the coarse gauge is displayed on the display more than a predetermined number of times in a predetermined period.

11. The display apparatus of claim 9, wherein the predetermined condition is whether a parameter of the item or a value of the coarse gauge is modified more than a predetermined number of times while the item or the coarse gauge is displayed on the display.

12. The display apparatus of claim 9, wherein the predetermined condition is whether the item or the coarse gauge has been displayed on the display for more than a predetermined period of time.

13. The display apparatus of claim 9, wherein an appearance of the fine gauge is different from an appearance of the coarse gauge.

14. The display apparatus of claim 9, wherein a width or a length of the fine gauge is substantially equal to a width or a length of the coarse gauge.

15. The display apparatus of claim 9, wherein the controller changes a value of the setting parameter with a larger step based on one user input when the coarse gauge is displayed on the display than the controller changes a value of the setting parameter when the fine gauge is displayed on the display.

16. The display apparatus of claim 9, wherein the controller displays the item and the plurality of items on a same menu on the display.

17. A display apparatus comprising:
a plurality of input terminals including a first input terminal and a second input terminal,
a display for selectably displaying an image based on a signal originated from one of the plurality of the input terminals and for displaying a menu for changing a setting of the display apparatus,
a controller for storing data of a parameter relating to the setting of the display apparatus, the data including a first datum corresponding to the first input terminal and a second datum corresponding to the second input terminal;
wherein when the display displays an image based on a signal originated from the first input terminal, the controller adjusts the image or modifies the menu based on the first datum,
wherein when the display displays an image based on a signal originated from the second input terminal, the controller adjusts the image or modifies the menu based on the second datum.

18. The display apparatus of claim 17, wherein the controller displays a menu containing a set of items on the display, and
wherein a set of items shown in the menu when the display displays an image based on a signal originated from the first input terminal is different from a set of items shown in the menu when the display displays an image based on a signal originated from the second input terminal.

19. The display apparatus of claim 18, wherein the set of items includes an item selected more than a predetermined number of times or an item registered by a user, and
wherein the item selected more than the predetermined number of times or the item registered by the user when the display displays an image based on a signal originated from the first input terminal is different from the item selected more than the predetermined number of times or the item registered by the user when the display displays an image based on a signal originated from the second input terminal.

20. The display apparatus of claim 17, wherein when the display displays an image based on a signal originated from the first input terminal, the controller changes the first datum based on a user input, and
wherein when the display displays an image based on a signal originated from the second input terminal, the controller changes the second datum based on a user input.
